(19) United States
(12) Patent Application Publication
(10) Pub. No.: US 2015/0262749 A1
(43) Pub. Date: Sep. 17, 2015

(54) Inherently Balanced Zero-Sequence Blocking Inductor (ZSBI)

(71) Applicant: Jacob Justice, Lubbock, TX (US)

(72) Inventor: Jacob Justice, Lubbock, TX (US)

(21) Appl. No.: 14/658,096

(22) Filed: Mar. 13, 2015

Related U.S. Application Data
(60) Provisional application No. 61/952,175, filed on Mar. 13, 2014.

(51) Int. Cl. H01F 27/34; H01F 30/12

(52) U.S. Cl. CPC H01F 27/34; H01F 30/12

(57) ABSTRACT

A device and method of use for a zero-sequence blocking inductor (ZSBI) is disclosed which has inherently balanced resistive characteristics. This is achieved by a physical construction that facilitates equal length coil windings for each phase, as opposed to the unequal length windings commonly produced with a conventional concentric winding configuration. With the zero-sequence blocking inductor's windings structured in such a manner, the inherently balanced resistive characteristic is achieved.

### CROSS-REFERENCE TO RELATED APPLICATIONS

This application claims the benefit under Title 35 United States Code §119(e) of U.S. Provisional Patent Application Ser. No.: 61/952,175; Filed: Mar. 13, 2014, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to a device and method of use directed to zero-sequence blocking inductors (ZSBI). More specifically, the present invention relates to a device and method of use for an inherently balanced zero-sequence blocking inductor which has or maintains an inherent resistive balance for enhanced performance.

### BACKGROUND OF THE INVENTION

Without limiting the scope of the disclosed device and method, the background is described in connection with a novel device and approach to provide improved harmonic mitigation and current balancing in zero-sequence blocking inductor-equipped circuits and systems.

The field's prior art reflects many approaches and devices in providing a means for improved zero-sequence blocking inductor performance. In the past, various design and construction techniques have been implemented on zero-sequence blocking inductors with the goal of improved performance, while maintaining a simple physical structure.

An example of a conventionally wound shell-type ZSBI is illustrated in the prior art of FIG. 1. In this example, individual phases are wound on top of one another in concentric layers. Therefore, each subsequent phase winding is constructed with a physically longer conductor than the one before it. With this approach, the winding length differential produces a resistive imbalance between the three phases. This problem is only exacerbated when multiple three phase groups are wound on the same core, as is the case in a six-phase (or higher) ZSBI.

While the aforementioned devices and approaches may fulfill their unique purposes, none of them fulfill the need for a practical and effective means of optimizing the resistive balance or the performance characteristics of a zero-sequence blocking inductor.

The present invention therefore proposes a novel device and method of use for dramatically improving the resistive balancing performance in zero-sequence blocking inductors.

### BRIEF SUMMARY OF THE INVENTION

The present invention, therefore, provides a device and method of use to provide improved performance in zero-sequence blocking inductors.

In one embodiment, the inherently balanced zero-sequence blocking inductor (ZSBI) has a shell-type or core-type construction with three phases, or a multiple thereof, wound with equal length sections containing an equal number of turns; in other words, resistance characteristics between phases are inherently balanced, or built into the device. Due to the basic characteristics of three phase power, or integer multiples thereof, the instantaneous sum of the fluxes induced in the core is zero, when wound on a common core. This means that a zero sequence current trying to move through the windings must magnetize the core and is effectively attenuated. When a group of windings sections are physically wound around the same core, it is said that that core is “common” to all of those windings. This results in the windings being magnetically coupled, whether they are electrically isolated or not.

The inherently balanced zero-sequence blocking inductor is best used in phase shifting auto transformers or in three phase systems where series insertion mitigates the flow of zero sequence currents and allows phase groups to operate independently of one another, as if fed by separate, electrically isolated supplies.

In summary, the present invention discloses an improved device and method of use to improve the performance of zero-sequence blocking inductors. More specifically, the present invention relates to a device and method of use for a zero-sequence blocking inductor that has inherently balanced resistive characteristics.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a front view winding representation of a prior art application of a conventionally wound shell type zero-sequence blocking inductor;

FIG. 2 is a top view winding representation of a prior art application of a conventionally wound shell type zero-sequence blocking inductor;

FIG. 3 is a front view device representation of a prior art application of a conventionally wound shell type zero-sequence blocking inductor;

FIG. 4 is a top view device representation of a prior art application of a conventionally wound shell type zero-sequence blocking inductor;

FIG. 5 is a front view winding representation of a shell type inherently balanced zero-sequence blocking inductor in accordance with embodiments of the disclosure;

FIG. 6 is a top view winding representation of a shell type inherently balanced zero-sequence blocking inductor in accordance with embodiments of the disclosure;

FIG. 7 is a front view device representation of a shell type inherently balanced zero-sequence blocking inductor in accordance with embodiments of the disclosure;

FIG. 8 is a top view device representation of a shell type inherently balanced zero-sequence blocking inductor in accordance with embodiments of the disclosure;

FIG. 9 is a front view winding representation of a core type inherently balanced zero-sequence blocking inductor in accordance with embodiments of the disclosure;

FIG. 10 is a top view winding representation of a core type inherently balanced zero-sequence blocking inductor in accordance with embodiments of the disclosure;

FIG. 11 is a front view device representation of a core type inherently balanced zero-sequence blocking inductor in accordance with embodiments of the disclosure;

FIG. 12 is a top view device representation of a core type inherently balanced zero-sequence blocking inductor in accordance with embodiments of the disclosure;

FIG. 13 is a front view winding representation of a shell type 6-phase inherently balanced zero-sequence blocking inductor in accordance with embodiments of the disclosure;

FIG. 14 is a top view winding representation of a shell type 6-phase inherently balanced zero-sequence blocking inductor in accordance with embodiments of the disclosure;

FIG. 15 is a front view device representation of a shell type 6-phase inherently balanced zero-sequence blocking inductor in accordance with embodiments of the disclosure;

FIG. 16 is a top view device representation of a shell type 6-phase inherently balanced zero-sequence blocking inductor in accordance with embodiments of the disclosure;

FIG. 17 is an environmental view of the inherently balanced zero sequence blocking inductor illustrated in a working circuit in accordance with embodiments of the disclosure.

### DETAILED DESCRIPTION OF THE INVENTION

Disclosed herein is an improved device and method of use for improving zero-sequence blocking inductors. The numerous innovative teachings of the present invention will be described with particular reference to several embodiments (by way of example, and not of limitation).

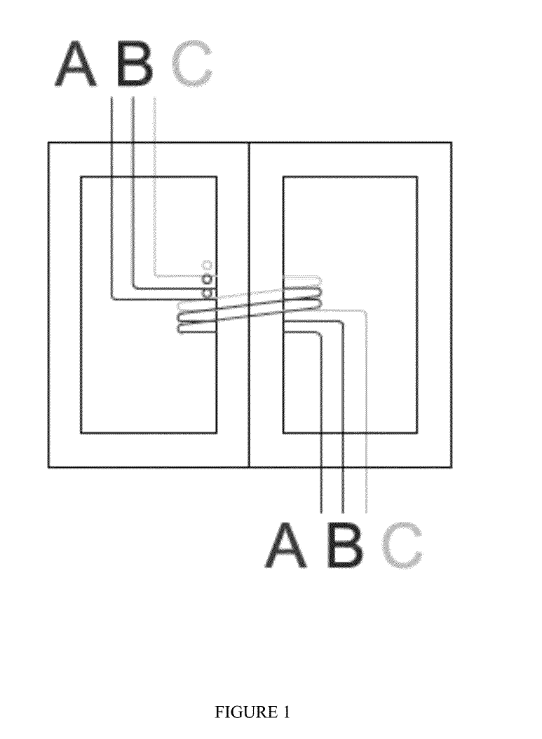

Reference is first made to FIG. 1, a front view winding-level representation of a prior art application of a conventionally wound shell-type zero-sequence blocking inductor. Each phase is fundamentally represented with one turn on the core, but practically you could use any number of turns here. In this illustration, as previously mentioned, in a conventionally wound shell-type zero-sequence blocking inductor, individual phases are wound on top of one another in concentric layers. Therefore, each subsequent phase winding is constructed with a physically longer conductor than the one before it. With this approach, the winding length differential produces a resistive imbalance between the three phases. This problem is only exacerbated when multiple three phase groups are wound on the same core, as is the case in a six-phase (or higher) ZSBI.

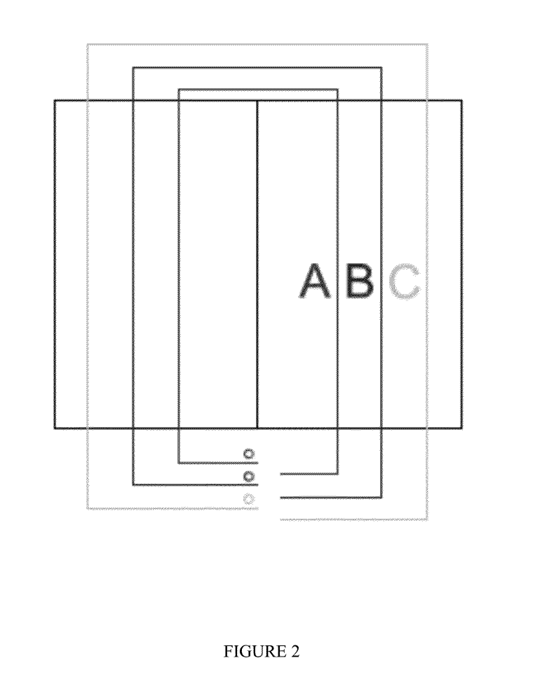

Reference is now made to FIG. 2, a top view winding representation of a prior art application of a conventionally wound shell type zero-sequence blocking inductor. In this top view illustration, it is easier to see the individual phases wound on top of one another in concentric layers producing with each subsequent phase winding a physically longer conductor than the one before it.

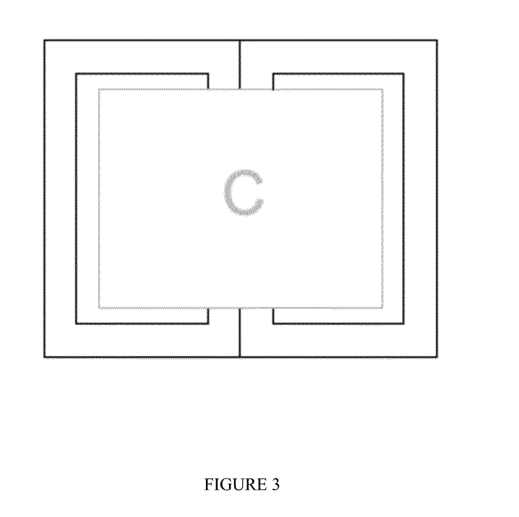

Reference is next made to FIG. 3, a front view device representation of a prior art application of a conventionally wound shell-type zero-sequence blocking inductor. In this illustration, the outer winding can be seen, but the two inner windings are hidden from view. This is the case with any conventionally wound shell type zero-sequence blocking inductor.

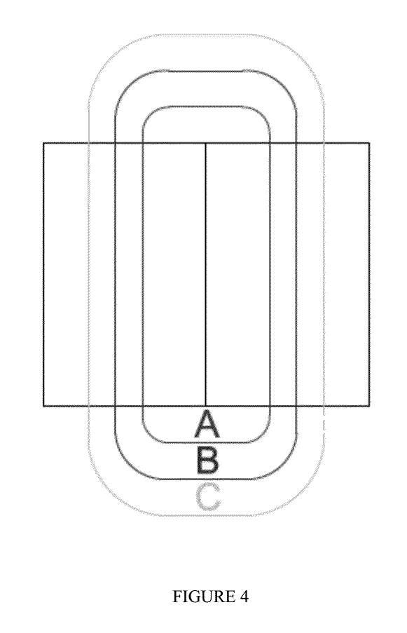

Reference is now made to FIG. 4, is a top view device representation of a prior art application of a conventionally wound shell type zero-sequence blocking inductor. In this top view illustration, more easily seen are the individual phases wound on top of one another in concentric layers producing with each subsequent phase winding a physically longer conductor than the one before it. Phase A is the innermost layer, followed by phase B, and then phase C. As can be seen in this illustration, phase A is the physically shortest winding while phase C is the physically longest winding in this construction type.

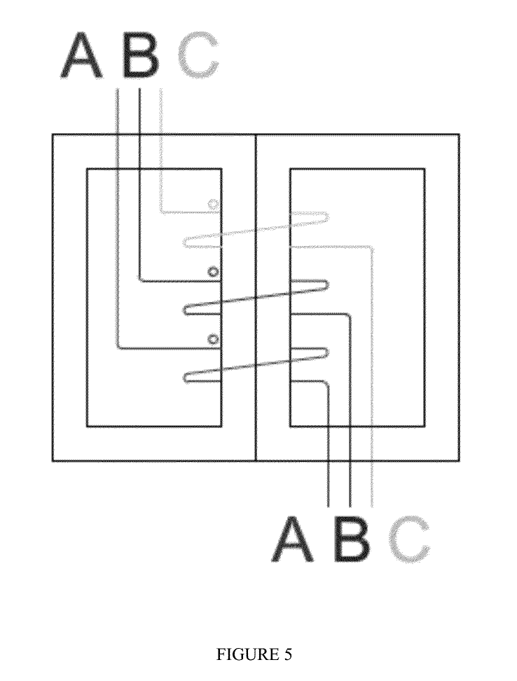

Reference is next made to FIG. 5, is a front view winding representation of a shell type inherently balanced zero-sequence blocking inductor in accordance with embodiments of the disclosure. In one embodiment, the inherently balanced zero-sequence blocking inductor (ZSBI) has a shell-type or core-type construction with three phases, or a multiple thereof, wound with equal length sections containing an equal number of turns; in other words, resistance characteristics between phases are inherently balanced, or built into the device. Due to the basic characteristics of three phase power, or integer multiples thereof, the instantaneous sum of the fluxes induced in the core is zero, when wound on a common core. This means that a zero sequence current trying to move through the windings must magnetize the core and is effectively attenuated. A core is common to a group of windings when they are physically, and therefore magnetically, coupled. In this embodiment, a shell type construction is used for the inherently balanced zero-sequence blocking inductor. In this configuration, identically constructed phase windings are arranged vertically along the core limb to produce equal physical length windings.

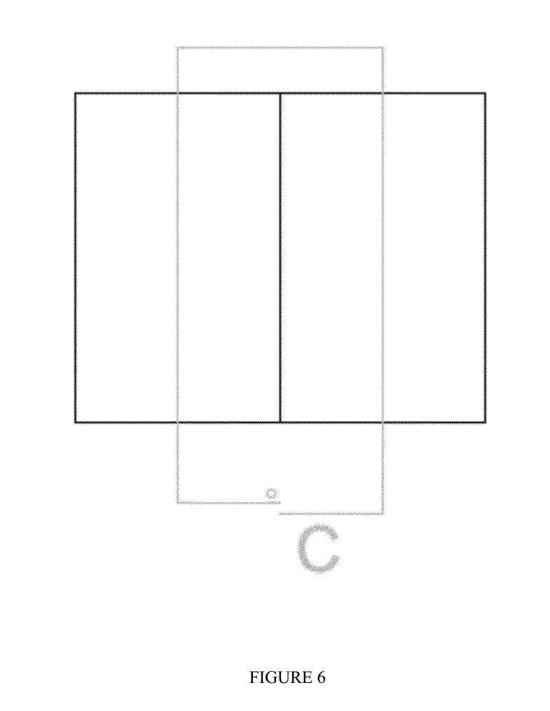

Reference is now made to FIG. 6, a top view winding representation of a shell-type inherently balanced zero-sequence blocking inductor in accordance with embodiments of the disclosure. It is illustrated in the fundamental, single-turn configuration, for simplicity's sake. Better illustrated in this view is the stacked configuration with phase C being shown on top. Phase B resides underneath phase C and phase A resides underneath phase B.

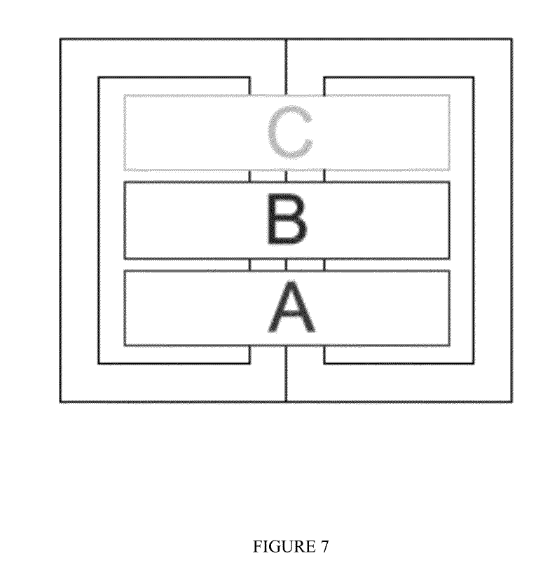

Reference is next made to FIG. 7, a front view device representation of a shell-type inherently balanced zero-sequence blocking inductor in accordance with embodiments of the disclosure. Illustrated in this figure are the phases are constructed as physically identical, magnetically coupled and electrically isolated assemblies that are vertically stacked on top of one another to produce equal physical length windings.

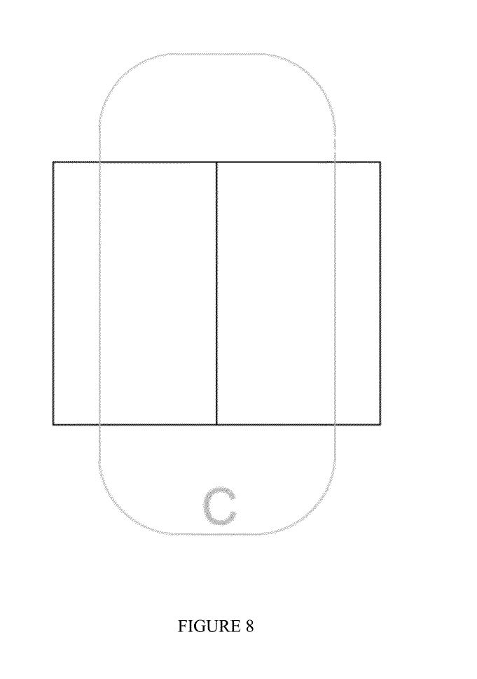

Reference is now made to FIG. 8, a top view device representation of a shell type inherently balanced zero-sequence blocking inductor in accordance with embodiments of the disclosure. Illustrated in this view is the stacked configuration with phase C being shown on top. Phase B resides underneath phase C and phase A resides underneath phase B.

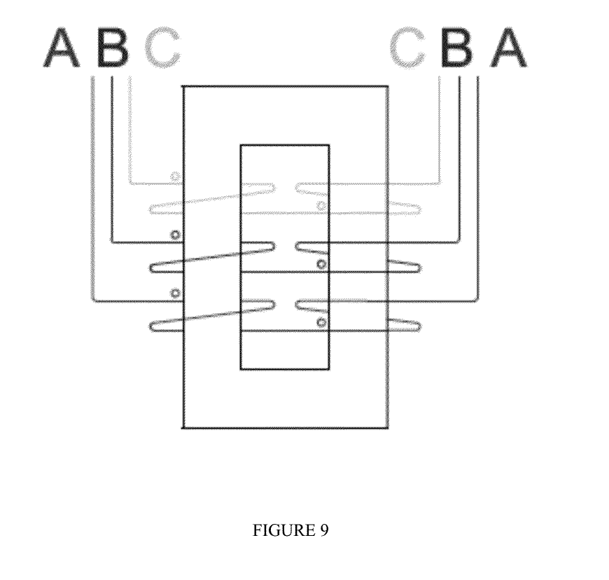

Reference is next made to FIG. 9, a front view winding representation of a core-type inherently balanced zero-sequence blocking inductor in accordance with embodiments of the disclosure. In another embodiment the inherently balanced zero sequence blocking inductor uses a core-type construction. In this configuration, the windings are also stacked to produce equal physical length windings, despite being divided into two equal pieces physically located on opposite sides of the core.

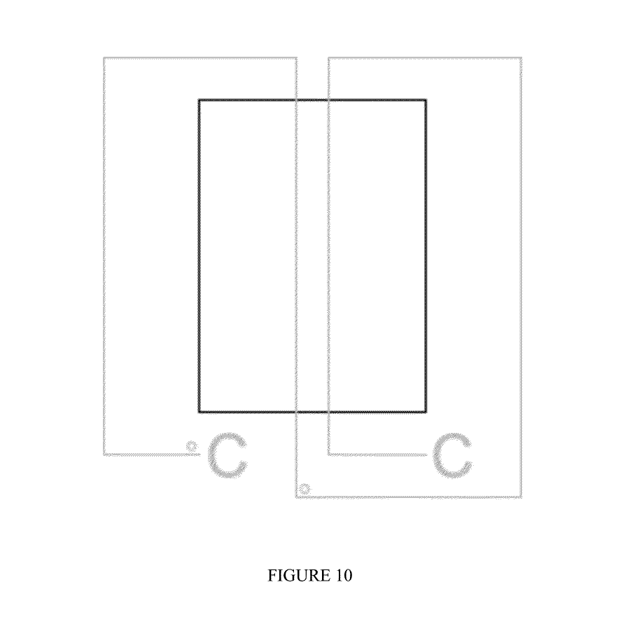

Reference is now made to FIG. 10, a top view winding representation of a core-type inherently balanced zero-sequence blocking inductor in accordance with embodiments of the disclosure. Each of the two coils are illustrated in the fundamental, single-turn configuration, for simplicity's sake. Better illustrated in this view is the stacked configuration with phase C being shown. Phase B resides underneath phase C and phase A resides underneath phase B, on both sides.

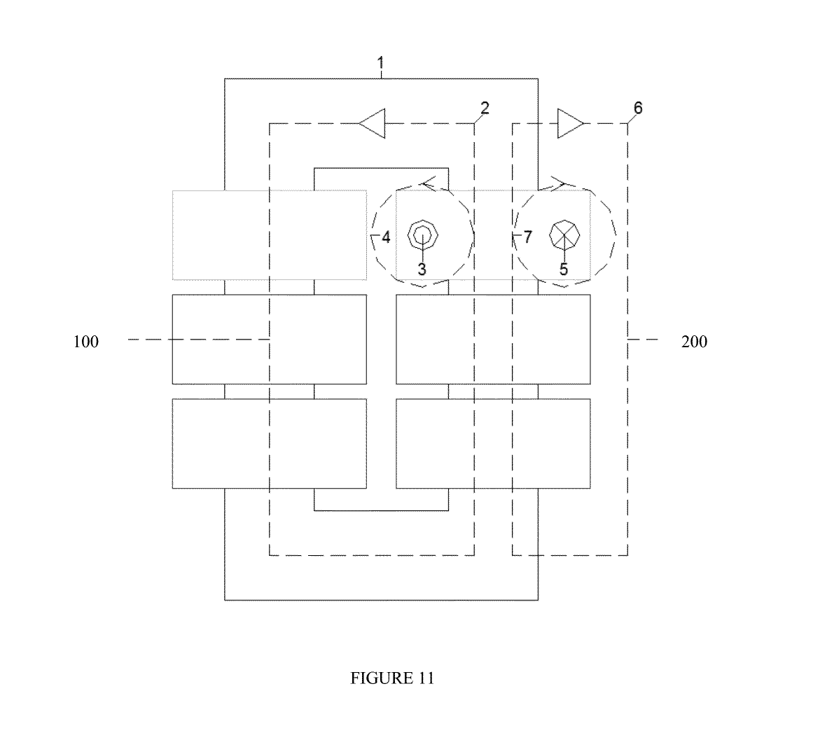

Reference is next made to FIG. 11, a front view device representation of a core type inherently balanced zero-sequence blocking inductor further illustrating the flux paths in accordance with embodiments of the disclosure. Illustrated in this figure is a 2-dimensional representation of the magnetic fields generated by one individual turn in a winding. The core 1 carries a flux 2 that is generated by moving a current through a single turn (in one of the three identical, yet electrically isolated windings) that passes through the core window and out of the page 3. This flux 2 represents the actual magnetic flow path of the theoretical field 4 that is produced by moving a current through this conductor 3 in this direction. The other end of the conductor bends around the front of the core and passes back into the page 5. The current that flows through it is the same current that flows in 3, as they form a continuous winding. This current now flows back into the page, so fields 2 & 4 rotate in the opposite direction relative to fields 6 & 7 in this two dimensional cross sectional representation. Flux 6 represents the actual magnetic flow path of the theoretical field 7 that is produced by this current flowing in this conductor 5. Notice that flux 6 returns outside the core. The core 1 is a high impedance magnetic path for these fluxes, whereas the surrounding air is a very low impedance magnetic path. Under normal operation, two of the three separate windings will be carrying the same current at any given time. The current will enter one winding and exit the other. Thus, the fluxes generating will be equal in magnitude and opposite in direction. This results in a net flux that is approximately equal to zero, so the whole core is available to be magnetized. Thus, the higher the magnetizing impedance of the ZSBI, the more it will limit any zero-sequence currents that attempt to flow through it. Using a core-type construction, where flux can return outside of the core, the magnetizing impedance of the zero sequence blocking inductor is substantially reduced compared to the shell-type construction, and for this reason it is not preferred.

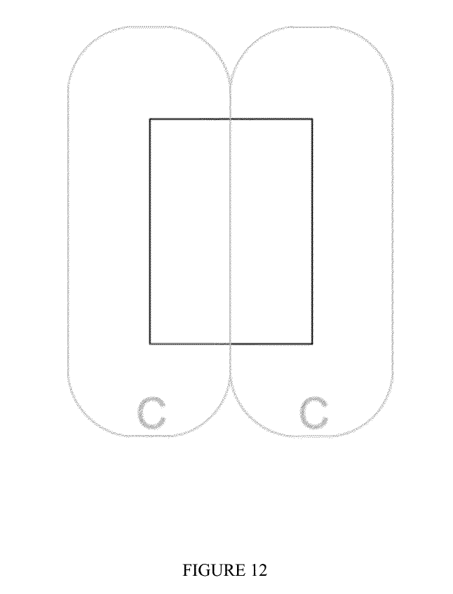

Reference is now made to FIG. 12, a top view device representation of a core type inherently balanced zero-sequence blocking inductor in accordance with embodiments of the disclosure. Illustrated in this view is the stacked configuration with phase C being shown. Phase B resides underneath phase C and phase A resides underneath phase B.

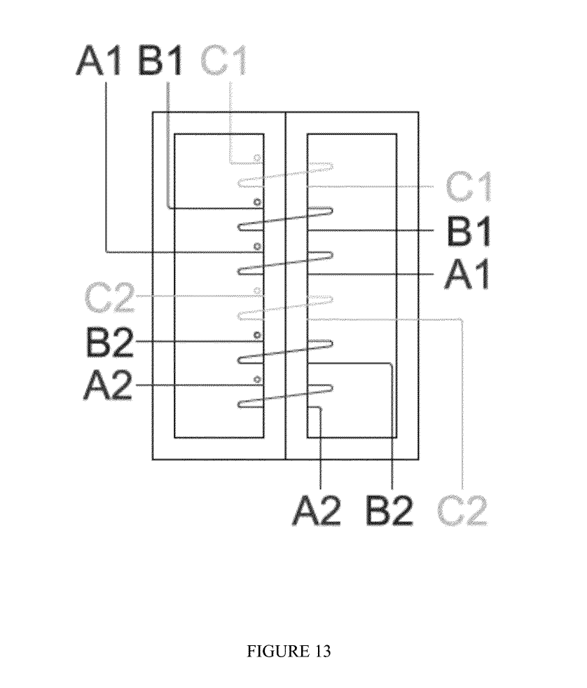

Reference is next made to FIG. 13, a front view winding representation of a shell type 6-phase inherently balanced zero-sequence blocking inductor in accordance with embodiments of the disclosure. In yet another embodiment, a 6-phase inherently balanced, zero-sequence blocking inductor is shown. Construction is similar to the three phase shell type construction as shown in FIG. 5, with an additional three phases added. Each three-phase group has two of its three coils loaded at any given instant, in 12-pulse operation. Each pair of coils produces two fluxes in the core that cancel each other out. Thus, the net flux of any six-phase (or other higher multiple of 3) ZSBI is still approximately zero, in operation.

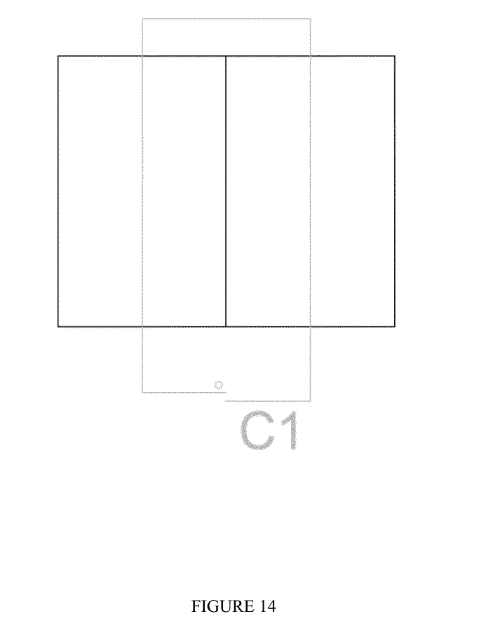

Reference is now made to FIG. 14, a top view winding representation of a shell type 6-phase inherently balanced zero-sequence blocking inductor in accordance with embodiments of the disclosure. Better illustrated in this view is the stacked configuration with phase C1 being shown. Phase B1 resides underneath phase C1 and phase A1 resides underneath phase B1. The additional three phases C2, B2, and A2 reside in that order underneath A1.

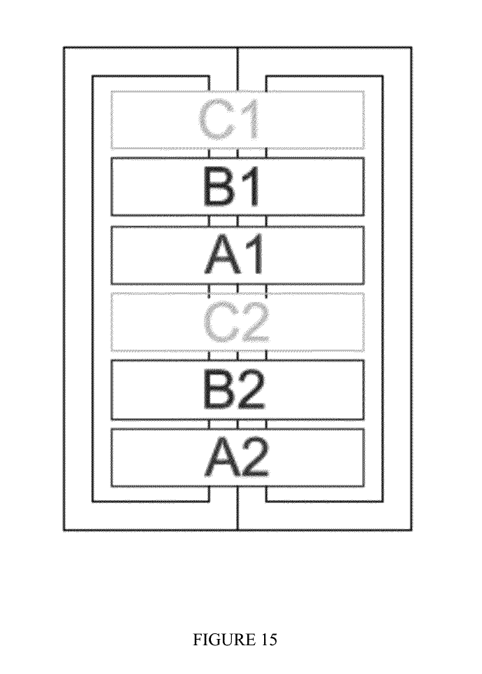

Reference is next made to FIG. 15, a front view device representation of a shell type 6-phase inherently balanced zero-sequence blocking inductor in accordance with embodiments of the disclosure. Illustrated in this figure are the stacked phases that produce equal physically length windings.

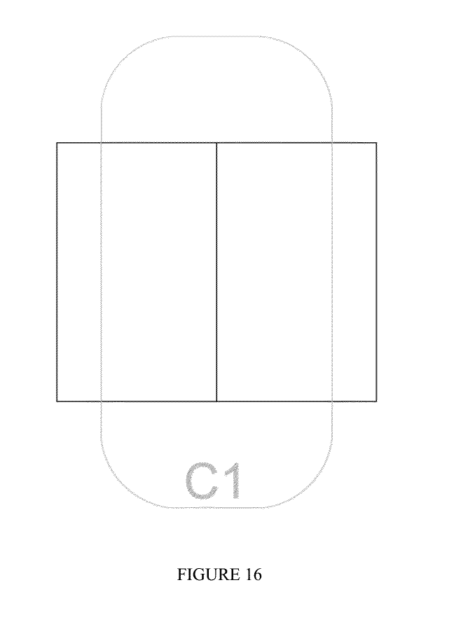

Reference is now made to FIG. 16, a top view device representation of a shell type 6-phase inherently balanced zero-sequence blocking inductor in accordance with embodiments of the disclosure. Illustrated in this view is the stacked configuration with phase C1 being shown. Phases B1, A1, C2, B2, and A2 reside underneath C1 in that order.

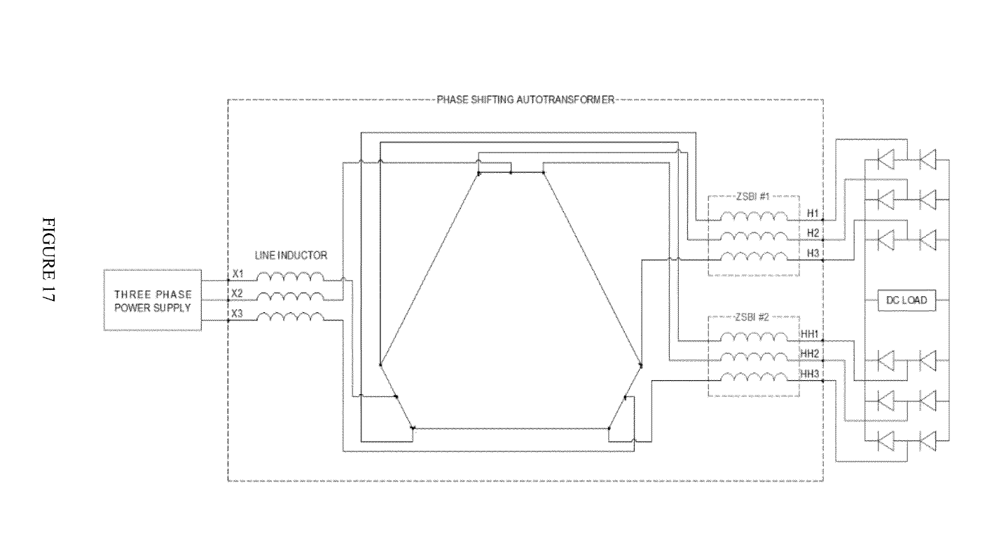

Reference is next made to FIG. 17, an environmental view of the inherently balanced zero sequence blocking inductor illustrated in a working circuit in accordance with embodiments of the disclosure. Seen in this illustration is an embodiment implementation of the inherently balanced zero sequence blocking inductor.

In brief, the present invention relates to a device and method of use to provide improved performance in zero-sequence blocking inductors.

The disclosed device and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims. Consequently, any embodiments comprising a one piece or multi piece device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and method of use described herein. Such equivalents are considered to be within the scope of this invention and are covered by the claims.

All publications and patent applications mentioned in the specification are indicative of the level of those skilled in the art to which this invention pertains. All publications and patent application are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The device and/or methods disclosed and claimed herein can be made and executed without undue experimentation in light of the present disclosure. While the device and methods of this invention have been described in terms of preferred embodiments, it will be apparent to those skilled in the art that variations may be applied to the device and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A zero-sequence blocking inductor comprising:
essentially equal length coil windings for each phase.

2. The zero-sequence blocking inductor of claim 1, wherein said zero-sequence blocking inductor is constructed using three phases.

3. The zero-sequence blocking inductor of claim 1, wherein said zero-sequence blocking inductor is constructed using a multiple of three phases.

4. The zero-sequence blocking inductor of claim 1, wherein said zero-sequence blocking inductor is constructed having the phase windings wound on a common core.

5. The zero-sequence blocking inductor of claim 1, wherein said zero-sequence blocking inductor is constructed using windings with equal length sections containing an equal number of turns and the core is common to a group of windings.

6. The zero-sequence blocking inductor of claim 1, wherein said zero-sequence blocking inductor is a shell-type construction.

7. The zero-sequence blocking inductor of claim 6, wherein said zero-sequence blocking inductor is constructed using three phases.

8. The zero-sequence blocking inductor of claim 6, wherein said zero-sequence blocking inductor is constructed using a multiple of three phases.

9. The zero-sequence blocking inductor of claim 6, wherein said zero-sequence blocking inductor is constructed having the phase windings wound on a common core.

10. The zero-sequence blocking inductor of claim 6, wherein said zero-sequence blocking inductor is constructed using windings with equal length sections containing an equal number of turns and the core is common to a group of windings.

11. The zero-sequence blocking inductor of claim 6, wherein said zero-sequence blocking inductor is constructed with identical phase windings arranged vertically along the core limb to produce equal length windings.

12. The zero-sequence blocking inductor of claim 11, wherein said zero-sequence blocking inductor is constructed wherein each phase winding is a single turn configuration.

13. The zero-sequence blocking inductor of claim 1, wherein said zero-sequence blocking inductor is a core-type construction.

14. The zero-sequence blocking inductor of claim 6, wherein said zero-sequence blocking inductor is constructed using three phases.

15. The zero-sequence blocking inductor of claim 6, wherein said zero-sequence blocking inductor is constructed using a multiple of three phases.

16. The zero-sequence blocking inductor of claim 6, wherein said zero-sequence blocking inductor is constructed having the phase windings wound on a common core.

17. The zero-sequence blocking inductor of claim 6, wherein said zero-sequence blocking inductor is constructed using windings with equal length sections containing an equal number of turns and the core is common to a group of windings.

18. The zero-sequence blocking inductor of claim 6, wherein said zero-sequence blocking inductor is constructed with identical phase windings arranged vertically along the core limb to produce equal length windings.

19. The zero-sequence blocking inductor of claim 11, wherein said zero-sequence blocking inductor is constructed wherein each phase winding is a single turn configuration.

20. A zero-sequence blocking inductor comprising:
essentially equal length coil windings for each phase;
and wherein said zero-sequence blocking inductor is further comprised of three phases or a multiple thereof;
and wherein said zero-sequence blocking inductor is further comprised of a shell type or a core type construction;
and wherein said windings are essentially equal length sections containing an equal number of turns and the core is common to a group of windings
